(19) United States
(12) Patent Application Publication
(10) Pub. No.: US 2023/0395830 A1
(43) Pub. Date: Dec. 7, 2023

(54) FUEL CELL POWER GENERATION SYSTEM AND CONTROL METHOD FOR FUEL CELL POWER GENERATION SYSTEM

(71) Applicant: MITSUBISHI HEAVY INDUSTRIES, LTD., Tokyo (JP)

(72) Inventors: Mitsuyoshi Iwata, Yokohama-shi (JP); Takahiro Machida, Yokohama-shi (JP); Nagao Hisatome, Yokohama-shi (JP)

(73) Assignee: MITSUBISHI HEAVY INDUSTRIES, LTD., Tokyo (JP)

(21) Appl. No.: 18/032,711

(22) PCT Filed: Oct. 26, 2021
(86) PCT No.: PCT/JP2021/039391

§ 371 Date: Apr. 19, 2023

(30) Foreign Application Priority Data
Oct. 30, 2020 (JP) 2020-183304

(51) Int. Cl. H01M 8/04228; H01M 8/04119; H01M 8/0432; H01M 8/04223

(52) U.S. Cl. CPC H01M 8/04228; H01M 8/04156; H01M 8/0432; H01M 8/04231; H01M 2008/1293

(57) ABSTRACT

A fuel cell power generation system includes: a fuel cell; a peripheral device used to operate the fuel cell; a resource storage part; and a resource supply part. The resource storage part is capable of storing a resource generated in the fuel cell in an operation/stop process of the fuel cell. The resource supply part is capable of supplying the resource stored in the resource storage part to at least either of the fuel cell or the peripheral device.

### TECHNICAL FIELD

The present disclosure relates to a fuel cell power generation system and a control method for the fuel cell power generation system.

This application claims the priority of Japanese Patent Application No. 2020-183304 filed on Oct. 30, 2020, the content of which is incorporated herein by reference.

### BACKGROUND

A fuel cell for generating power by chemically reacting a fuel gas and an oxidizing gas has characteristics such as excellent power generation efficiency and environmental responsiveness. Among these, a solid oxide fuel cell (SOFC) uses ceramics such as zirconia ceramics as an electrolyte and generates power by supplying, as a fuel gas, a gas such as a gasification gas obtained by producing reducing gas, city gas, natural gas, petroleum, methanol, and a carbon-containing raw material with a gasification facility, and causing reaction in a high-temperature atmosphere of approximately 700° C. to 1,000° C.

As a power generation system using such fuel cell, for example, a fuel cell power generation system as disclosed in Patent Document 1 is known. Patent Document 1 discloses a fuel cell power generation system in which power generation efficiency of the system as a whole is improved by including a plurality of fuel cells with a first fuel cell and a second fuel cell, and in particular, generating power in the second fuel cell with an exhaust fuel gas exhausted from the first fuel cell.

### CITATION LIST

### Patent Literature

Patent Document 1: JP3924243B

### SUMMARY

### Technical Problem

In this type of fuel power generation system, regardless of the type of fuel cell (SOFC, PEFE, PAFC, MCFC, etc.) employed, in addition to a fuel cell body, a peripheral device necessary to operate the system is provided. Such peripheral device includes, for example, a means (cylinder, etc.) for supplying an inert gas, an anode reducing gas, etc. for preventing deterioration in cell part of a fuel cell under a high-temperature environment in the process of starting/stopping the fuel cell power generation system, or in a pressurized fuel cell power generation system in which a pressurized gas is supplied by a turbocharger (T/C) during steady operation, an air compressor, a pressurized combustor, etc. for supplying the pressurized gas instead of the turbocharger at startup when air cannot be supplied by the turbocharger.

In recent years, as the capacity of the fuel cell power generation system has increased, the number of peripheral devices required for the fuel cell power generation system tends to increase. The increase in number of peripheral devices not only increases an installation space or an initial cost of the system, but also causes an increase in running cost or a decrease in power generation efficiency due to an increase in energy consumption during system operation.

At least one aspect of the present disclosure is made in view of the above, and an object of the present disclosure is to provide a fuel cell power generation system that can be operated at low cost by reducing an installation space and reducing peripheral equipment and necessary utility, and a control method for the fuel cell power generation system.

### Solution to Problem

In order to solve the above-described problems, a fuel cell power generation system according to at least one aspect of the present disclosure includes: a fuel cell; a peripheral device used to operate the fuel cell; a resource storage part capable of storing a resource generated in the fuel cell in an operation/stop process of the fuel cell; and a resource supply part capable of supplying the resource stored in the resource storage part to at least either of the fuel cell or the peripheral device.

In order to solve the above-described problems, a control method for a fuel cell power generation system is a control method for a fuel cell power generation system that includes a fuel cell, and a peripheral device used to operate the fuel cell, including: a step of storing a resource generated in the fuel cell in an operation/stop process of the fuel cell; and a step of supplying the resource to at least either of the fuel cell or the peripheral device.

### Advantageous Effects

At least one aspect of the present disclosure, it is possible to provide a fuel cell power generation system that can be operated at low cost by reducing an installation space and improving system efficiency, and a control method for the fuel cell power generation system.

### BRIEF DESCRIPTION OF DRAWINGS

FIG. 1 is a schematic view of a SOFC module (fuel cell module) according to an embodiment.

FIG. 2 is a schematic cross-sectional view of a SOFC cartridge (fuel cell cartridge) composing the SOFC module (fuel cell module) according to an embodiment.

FIG. 3 is a schematic cross-sectional view of a cell stack composing the SOFC module (fuel cell module) according to an embodiment.

FIG. 4 is a schematic configuration diagram of a fuel cell power generation system according to an embodiment.

FIG. 5 is a time chart diagram showing a temperature change from a stop process to a start process of the fuel cell power generation system.

FIG. 6A is a diagram showing an operating state of the fuel cell power generation system in a period P1 of FIG. 5.

FIG. 6B is a diagram showing an operating state of the fuel cell power generation system in a period P2 of FIG. 5.

FIG. 6C is a diagram showing an operating state of the fuel cell power generation system in a period P3 of FIG. 5.

FIG. 6D is a diagram showing an operating state of the fuel cell power generation system in a period P4 of FIG. 5.

FIG. 6E is a diagram showing an operating state of the fuel cell power generation system in a period P5 of FIG. 5.

FIG. 6F is a diagram showing an operating state of the fuel cell power generation system in a period P7 of FIG. 5. FIG. 6G is a diagram showing an operating state of the fuel cell power generation system in a period P8 of FIG. 5.

FIG. 6H is a diagram showing an operating state of the fuel cell power generation system in a period P9 of FIG. 5.

FIG. 7 is a table showing operating states of the respective configurations of the fuel cell power generation system in the respective periods P1 to P9 of FIG. 5.

### DETAILED DESCRIPTION

Some embodiments of the present invention will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

In the following, for descriptive convenience, positional relationships among respective components described using expressions “upper” and “lower” with reference to the drawing indicate the vertically upper side and the vertically lower side, respectively. Further, in the present embodiment, as long as the same effect is obtained in the up-down direction and the horizontal direction, the up-down direction in the drawing is not necessarily limited to the vertical up-down direction but may correspond to, for example, the horizontal direction orthogonal to the vertical direction.

Hereinafter, an embodiment in which a solid oxide fuel cell (SOFC) is adopted as a fuel cell composing a fuel cell power generation system will be described. However, in some embodiments, as the fuel cell composing the fuel cell power generation system, a fuel cell of a type other than the SOFC (for example, molten-carbonate fuel cells (MCFC), etc.) may be adopted.

(Configuration of Fuel Cell Module)

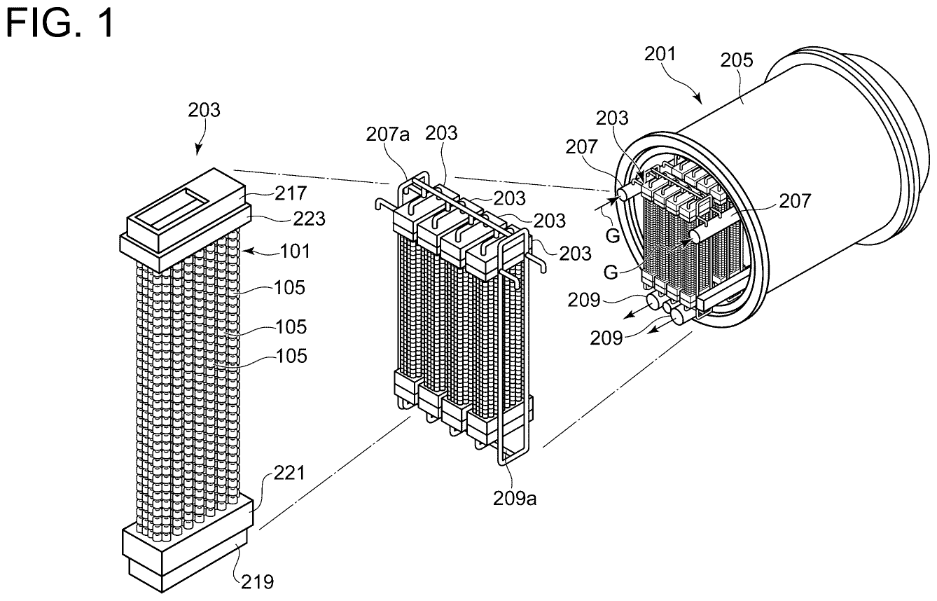

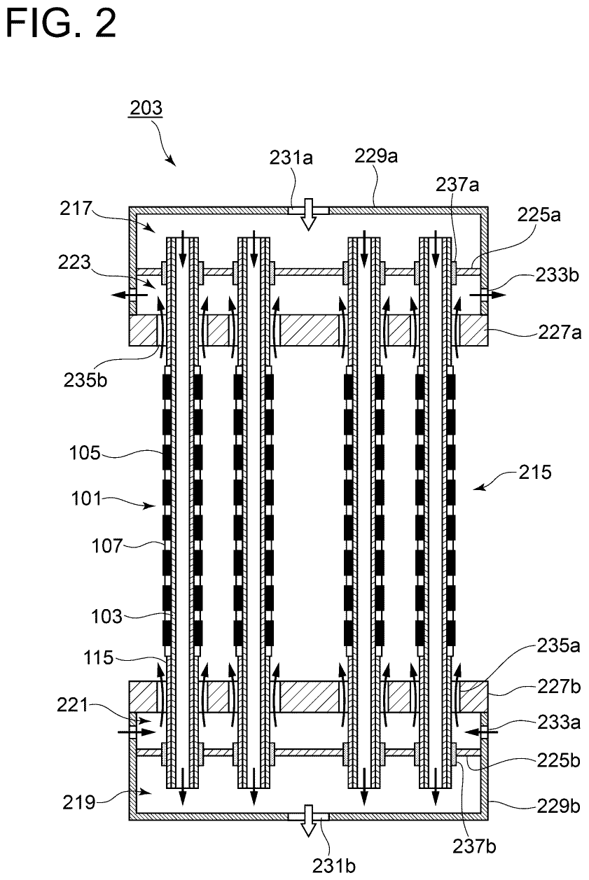

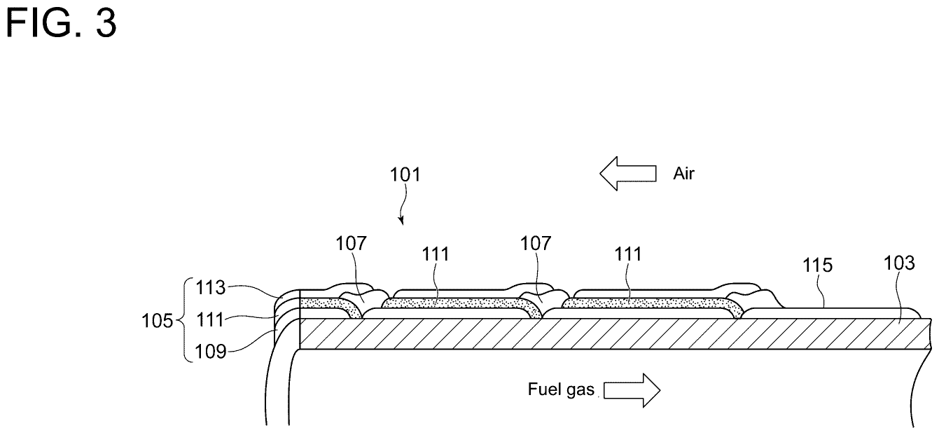

First, a fuel cell module composing a fuel cell power generation system according to some embodiments will be described with reference to FIGS. 1 to 3. FIG. 1 is a schematic view of a SOFC module (fuel cell module) according to an embodiment. FIG. 2 is a schematic cross-sectional view of a SOFC cartridge (fuel cell cartridge) composing the SOFC module (fuel cell module) according to an embodiment. FIG. 3 is a schematic cross-sectional view of a cell stack composing the SOFC module (fuel cell module) according to an embodiment.

As shown in FIG. 1, a SOFC module (fuel cell module) 201 includes, for example, a plurality of SOFC cartridges (fuel cell cartridges) 203 and a pressure vessel 205 for housing the plurality of SOFC cartridges 203. Although FIG. 1 illustrates a cylindrical SOFC cell stack 101, the present disclosure is not necessarily limited thereto and, for example, a flat cell stack may be used. Further, the fuel cell module 201 includes fuel gas supply pipes 207, a plurality of fuel gas supply branch pipes 207a, fuel gas exhaust pipes 209, and a plurality of fuel gas exhaust branch pipes 209a. Furthermore, the fuel cell module 201 includes an oxidant supply pipe (not shown) and an oxidant supply branch pipe (not shown), and an oxidant exhaust pipe (not shown) and a plurality of oxidant exhaust branch pipes (not shown).

The fuel gas supply pipes 207 are disposed outside the pressure vessel 205, are connected to a fuel gas supply part (not shown) for supplying a fuel gas having a predetermined gas composition and a predetermined flow rate according to a power generation amount of the fuel cell module 201, and are connected to the plurality of fuel gas supply branch pipes 207a. The fuel gas supply pipes 207 branch and introduce the predetermined flow rate of the fuel gas, which is supplied from the fuel gas supply part described above, to the plurality of fuel gas supply branch pipes 207a. Further, the fuel gas supply branch pipes 207a are connected to the fuel gas supply pipes 207 and are connected to the plurality of SOFC cartridges 203. The fuel gas supply branch pipes 207a introduce the fuel gas supplied from the fuel gas supply pipes 207 to the plurality of SOFC cartridges 203 at the substantially equal flow rate, and substantially uniformize power generation performance of the plurality of SOFC cartridges 203.

The fuel gas exhaust branch pipes 209a are connected to the plurality of SOFC cartridges 203 and are connected to the fuel gas exhaust pipes 209. The fuel gas exhaust branch pipes 209a introduce an exhaust fuel gas exhausted from the SOFC cartridges 203 to the fuel gas exhaust pipes 209. Further, the fuel gas exhaust pipes 209 are connected to the plurality of fuel gas exhaust branch pipes 209a, and a part of each of the fuel gas exhaust pipes 209 is disposed outside the pressure vessel 205. The fuel gas exhaust pipes 209 introduce the exhaust fuel gas derived from the fuel gas exhaust branch pipes 209a at the substantially equal flow rate to the outside of the pressure vessel 205.

The pressure vessel 205 is operated at an internal pressure of 0.1 MPa to approximately 3 MPa and an internal temperature from atmospheric temperature to approximately 550° C., and thus a material is used which has pressure resistance and corrosion resistance to an oxidizing agent such as oxygen contained in an oxidizing gas. For example, a stainless steel material such as SUS304 is suitable.

Herein, in the present embodiment, a mode is described in which the plurality of SOFC cartridges 203 are assembled and housed in the pressure vessel 205. However, the present disclosure is not limited thereto, and for example, a mode can also be adopted in which the SOFC cartridges 203 are housed in the pressure vessel 205 without being assembled.

As shown in FIG. 2, the SOFC cartridge 203 includes the plurality of cell stacks 101, a power generation chamber 215, a fuel gas supply header 217, a fuel gas exhaust header 219, an oxidizing gas (air) supply header 221, and an oxidant exhaust header 223. Further, the SOFC cartridge 203 includes an upper tube plate 225a, a lower tube plate 225b, an upper heat insulating body 227a, and a lower heat insulating body 227b.

In the present embodiment, the fuel gas supply header 217, the fuel gas exhaust header 219, the oxidant supply header 221, and the oxidant exhaust header 223 are disposed as shown in FIG. 2, whereby the SOFC cartridge 203 has a structure such that the fuel gas and the oxidizing gas oppositely flow on the inner side and the outer side of the cell stack 101. However, this is not always necessary and, for example, the fuel gas and the oxidizing gas may flow in parallel on the inner side and the outer side of the cell stack 101 or the oxidizing gas may flow in a direction orthogonal to the longitudinal direction of the cell stack 101.

The power generation chamber 215 is an area formed between the upper heat insulating body 227a and the lower heat insulating body 227b. The power generation chamber 215 is an area in which a single fuel cell 105 of the cell stack 101 is disposed, and is an area in which the fuel gas and the oxidizing gas are electrochemically reacted to generate power. Further, a temperature in the vicinity of the central portion of the power generation chamber 215 in the longitudinal direction of the cell stack 101 is monitored by a temperature measurement part (a temperature sensor such as a thermocouple), and becomes a high-temperature atmosphere of approximately 700° C. to 1,000° C. during a steady operation of the fuel cell module 201.

The fuel gas supply header 217 is an area surrounded by an upper casing 229a and the upper tube plate 225a of the SOFC cartridge 203, and communicates with the fuel gas supply branch pipe 207a through a fuel gas supply hole 231a disposed at the top of the upper casing 229a. Further, the plurality of cell stacks 101 are joined to the upper tube plate 225a by a seal component 237a, and the fuel gas supply header 217 introduces the fuel gas, which is supplied from the fuel gas supply branch pipe 207a via the fuel gas supply hole 231a, into substrate tubes 103 of the plurality of cell stacks 101 at the substantially uniform flow rate and substantially uniformizes the power generation performance of the plurality of cell stacks 101.

The fuel gas exhaust header 219 is an area surrounded by a lower casing 229b and the lower tube plate 225b of the SOFC cartridge 203, and communicates with the fuel gas exhaust branch pipe 209a (not shown) through a fuel gas exhaust hole 231b provided in the lower casing 229b. Further, the plurality of cell stacks 101 are joined to the lower tube plate 225b by a seal component 237b, and the fuel gas exhaust header 219 collects the exhaust fuel gas, which is supplied to the fuel gas exhaust header 219 through the inside of the substrate tubes 103 of the plurality of cell stacks 101, and introduces the collected exhaust fuel gas to the fuel gas exhaust branch pipe 209avia the fuel gas exhaust hole 231b.

The oxidizing gas having the predetermined gas composition and the predetermined flow rate is branched to the oxidant supply branch pipe according to the power generation amount of the fuel cell module 201, and is supplied to the plurality of SOFC cartridges 203. The oxidant supply header 221 is an area surrounded by the lower casing 229b, the lower tube plate 225b, and the lower heat insulating body (support) 227b of the SOFC cartridge 203, and communicates with the oxidant supply branch pipe (not shown) through an oxidant supply hole 23a disposed in a side surface of the lower casing 229b. The oxidant supply header 221 introduces the predetermined flow rate of the oxidizing gas, which is supplied from the oxidant supply branch pipe (not shown) via the oxidant supply hole 233a, to the power generation chamber 215 via an oxidant supply gap 235a described later.

The oxidant exhaust header 223 is an area surrounded by the upper casing 229a, the upper tube plate 225a, and the upper heat insulating body (support) 227a of the SOFC cartridge 203, and communicates with the oxidant exhaust branch pipe (not shown) through an oxidant exhaust hole 233b disposed in a side surface of the upper casing 229a. The oxidant exhaust header 223 introduces the exhaust oxidized gas, which is supplied to the oxidant exhaust header 223 via an oxidant exhaust gap 235bdescribed later, from the power generation chamber 215 to the oxidant exhaust branch pipe (not shown) via the oxidant exhaust hole 233b.

The upper tube plate 225a is fixed to side plates of the upper casing 229a such that the upper tube plate 225a, a top plate of the upper casing 229a, and the upper heat insulating body 227a are substantially parallel to each other, between the top plate of the upper casing 229a and the upper heat insulating body 227a. Further, the upper tube plate 225a has a plurality of holes corresponding to the number of cell stacks 101 provided in the SOFC cartridge 203, and the cell stacks 101 are inserted into the holes, respectively. The upper tube plate 225a air-tightly supports one end of each of the plurality of cell stacks 101 via either or both of the seal component 237a and an adhesive material, and isolates the fuel gas supply header 217 from the oxidant exhaust header 223.

The upper heat insulating body 227a is disposed at a lower end of the upper casing 229a such that the upper heat insulating body 227a, the top plate of the upper casing 229a, and the upper tube plate 225a are substantially parallel to each other, and is fixed to the side plates of the upper casing 229a. Further, the upper heat insulating body 227a has a plurality of holes corresponding to the number of cell stacks 101 provided in the SOFC cartridge 203. Each of the holes has a diameter which is set to be larger than the outer diameter of the cell stack 101. The upper heat insulating body 227a includes the oxidant exhaust gap 235b which is formed between an inner surface of the hole and an outer surface of the cell stack 101 inserted through the upper heat insulating body 227a.

The upper heat insulating body 227a separates the power generation chamber 215 and the oxidant exhaust header 223, and suppresses a decrease in strength or an increase in corrosion by an oxidizing agent contained in the oxidizing gas due to an increased temperature of the atmosphere around the upper tube plate 225a. The upper tube plate 225a or the like is made of a metal material having high temperature durability such as inconel, and thermal deformation is prevented which is caused by exposing the upper tube plate 225a or the like to a high temperature in the power generation chamber 215 and increasing a temperature difference in the upper tube plate 225a or the like. Further, the upper heat insulating body 227a introduces an exhaust oxidized gas, which has passed through the power generation chamber 215 and exposed to the high temperature, to the oxidant exhaust header 223 through the oxidant exhaust gap 235b.

According to the present embodiment, due to the structure of the SOFC cartridge 203 described above, the fuel gas and the oxidizing gas oppositely flow on the inner side and the outer side of the cell stack 101. Consequently, the exhaust oxidized gas exchanges heat with the fuel gas supplied to the power generation chamber 215 through the inside of the substrate tube 103, is cooled to a temperature at which the upper tube plate 225a or the like made of the metal material is not subjected to deformation such as buckling, and is supplied to the oxidant exhaust header 223. Further, the fuel gas is raised in temperature by the heat exchange with the exhaust oxidized gas exhausted from the power generation chamber 215 and supplied to the power generation chamber 215. As a result, the fuel gas, which is preheated and raised in temperature to a temperature suitable for power generation without using a heater or the like, can be supplied to the power generation chamber 215.

The lower tube plate 225b is fixed to side plates of the lower casing 229b such that the lower tube plate 225b, a bottom plate of the lower casing 229b, and the lower heat insulating body 227b are substantially parallel to each other, between the bottom plate of the lower casing 229b and the lower heat insulating body 227b. Further, the lower tube plate 225b has a plurality of holes corresponding to the number of cell stacks 101 provided in the SOFC cartridge 203, and the cell stacks 101 are inserted into the holes, respectively. The lower tube plate 225b air-tightly supports another end of each of the plurality of cell stacks 101 via either or both of the seal component 237b and the adhesive material, and isolates the fuel gas exhaust header 219 from the oxidant supply header 221.

The lower heat insulating body 227b is disposed at an upper end of the lower casing 229b such that the lower heat insulating body 227b, the bottom plate of the lower casing 229b, and the lower tube plate 225b are substantially parallel to each other, and is fixed to the side plates of the lower casing 229b. Further, the lower heat insulating body 227b has a plurality of holes corresponding to the number of cell stacks 101 provided in the SOFC cartridge 203. Each of the holes has a diameter which is set to be larger than the outer diameter of the cell stack 101. The lower heat insulating body 227b includes the oxidant supply gap 235a which is formed between an inner surface of the hole and the outer surface of the cell stack 101 inserted through the lower heat insulating body 227b.

The lower heat insulating body 227b separates the power generation chamber 215 and the oxidant supply header 221, and suppresses the decrease in strength or the increase in corrosion by the oxidizing agent contained in the oxidizing gas due to an increased temperature of the atmosphere around the lower tube plate 225b. The lower tube plate 225b or the like is made of the metal material having high temperature durability such as inconel, and thermal deformation is prevented which is caused by exposing the lower tube plate 225b or the like to a high temperature and increasing a temperature difference in the lower tube plate 225b or the like. Further, the lower heat insulating body 227b introduces the oxidizing gas, which is supplied to the oxidant supply header 221, to the power generation chamber 215 through the oxidant supply gap 235a.

According to the present embodiment, due to the structure of the SOFC cartridge 203 described above, the fuel gas and the oxidizing gas oppositely flow on the inner side and the outer side of the cell stack 101. Consequently, the exhaust fuel gas having passed through the power generation chamber 215 through the inside of the substrate tube 103 exchanges heat with the oxidizing gas supplied to the power generation chamber 215, is cooled to a temperature at which the lower tube plate 225b or the like made of the metal material is not subjected to deformation such as buckling, and is supplied to the fuel gas exhaust header 219. Further, the oxidizing gas is raised in temperature by the heat exchange with the exhaust fuel gas and supplied to the power generation chamber 215. As a result, the oxidizing gas, which is raised to a temperature needed for power generation without using the heater or the like, can be supplied to the power generation chamber 215.

After being derived to the vicinity of the end of the cell stack 101 by a lead film 115 which is disposed in the plurality of single fuel cells 105 and is made of Ni/YSZ or the like, DC power generated in the power generation chamber 215 is collected to a power collector rod (not shown) of the SOFC cartridge 203 via a power collector plate (not shown), and is taken out of each SOFC cartridge 203. The DC power derived to the outside of the SOFC cartridge 203 by the power collector rod interconnects the generated powers of the respective SOFC cartridges 203 by a predetermined series number and parallel number, and is derived to the outside of the fuel cell module 201, is converted into predetermined AC power by a power conversion device (an inverter or the like) such as a power conditioner (not shown), and is supplied to a power supply destination (for example, a load system or a power system).

As shown in FIG. 3, the cell stack 101 includes the cylindrical-shaped substrate tube 103 as an example, the plurality of single fuel cells 105 formed on an outer circumferential surface of the substrate tube 103, and an interconnector 107 formed between the adjacent single fuel cells 105. Each of the single fuel cells 105 is formed by laminating a fuel-side electrode 109, an electrolyte 111, and an oxygen-side electrode 113. Further, the cell stack 101 includes the lead film 115 electrically connected via the interconnector 107 to the oxygen-side electrode 113 of the single fuel cell 105 formed at farthest one end of the substrate tube 103 in the axial direction and includes the lead film 115 electrically connected to the fuel-side electrode 109 of the single fuel cell 105 formed at farthest another end, among the plurality of single fuel cells 105 formed on the outer circumferential surface of the substrate tube 103.

The substrate tube 103 is made of a porous material and includes, for example, CaO stabilized ZrO₂ (CSZ), a mixture (CSZ+NiO) of CSZ and nickel oxide (NiO), or Y₂O₃ stabilized ZrO₂ (YSZ), MgAl₂O₄ or the like as a main component. The substrate tube 103 supports the single fuel cells 105, the interconnector 107, and the lead film 115, and diffuses the fuel gas supplied to an inner circumferential surface of the substrate tube 103 to the fuel-side electrode 109 formed on the outer circumferential surface of the substrate tube 103 via a pore of the substrate tube 103.

The fuel-side electrode 109 is composed of an oxide of a composite material of Ni and a zirconia-based electrolyte material and, for example, Ni/YSZ is used. The fuel-side electrode 109 has a thickness of 50 μm to 250 μm, and the fuel-side electrode 109 may be formed by screen-printing a slurry. In this case, in the fuel-side electrode 109, Ni which is the component of the fuel-side electrode 109 has catalysis on the fuel gas. The catalysis reacts the fuel gas supplied via the substrate tube 103, for example, a mixed gas of methane (CH₄) and water vapor to be reformed into reducing gas (H₂) and carbon monoxide (CO). Further, the fuel-side electrode 109 electrochemically reacts reducing gas (H₂) and carbon monoxide (CO) obtained by the reformation with oxygen ions (O₂) supplied via the electrolyte 111 in the vicinity of the interface with the electrolyte 111 to produce water (H₂O) and carbon dioxide (CO₂). At this time, the single fuel cell 105 generate power by electrons emitted from oxygen ions.

The fuel gas, which can be supplied to and used for the fuel-side electrode 109 of the solid oxide fuel cell, includes, for example, a gasification gas produced from petroleum, methanol, and a carbon-containing raw material such as coal by a gasification facility, in addition to reducing gas (H₂) and carbonized reducing gas-based gas of carbon monoxide (CO), methane (CH₄), or the like, city gas, or natural gas.

As the electrolyte 111, YSZ is mainly used which has a gas-tight property that makes it difficult for a gas to pass through and a high oxygen ion conductive property at high temperature. The electrolyte 111 moves the oxygen ions (O²⁻) generated in the oxygen-side electrode to the fuel-side electrode. The electrolyte 111 located on a surface of the fuel-side electrode 109 has a film thickness of 10 μm to 100 μm, and the electrolyte 111 may be formed by screen-printing the slurry.

The oxygen-side electrode 113 is composed of, for example, LaSrMnO₃-based oxide or LaCoO₃-based oxide, and the oxygen-side electrode 113 is coated with the slurry by using screen-printing or a dispenser. The oxygen-side electrode 113 dissociates oxygen in the oxidizing gas such as supplied air to generate oxygen ions (O₂₋), in the vicinity of the interface with the electrolyte 111.

The oxygen-side electrode 113 can also have a two-layer structure. In this case, the oxygen-side electrode layer (oxygen-side electrode intermediate layer) on the electrolyte 111 side is made of a material which shows a high ion conductive property and is excellent in catalytic activity. The oxygen-side electrode layer (oxygen-side electrode conductive layer) on the oxygen-side electrode intermediate layer may be composed of a perovskite-type oxide represented by Sr and Ca-doped LaMnO₃. Thus, it is possible to further improve power generation performance.

The oxidizing gas is a gas containing approximately 15% to 30% of oxygen, and air is representatively suitable. Besides air, however, a mixed gas of a combustion exhaust gas and air, a mixed gas of oxygen and air, or the like can be used.

The interconnector 107 is composed of a conductive perovskite-type oxide represented by M₁₋ₓLₓTiO₃ (M is an alkaline earth metal element, L is a lanthanoid element) such as SrTiO₃ system, and screen-prints the slurry. The interconnector 107 has a dense film so that the fuel gas and the oxidizing gas do not mix with each other. Further, the interconnector 107 has stable durability and electrical conductivity under both an oxidizing atmosphere and a reducing atmosphere. In the adjacent single fuel cells 105, the interconnector 107 electrically connects the oxygen-side electrode 113 of the one single fuel cell 105 and the fuel-side electrode 109 of another single fuel cell 105, and connects the adjacent single fuel cell cells 105 to each other in series.

The lead film 115 needs to have electron conductivity and a thermal expansion coefficient close to that of another material composing the cell stack 101, and is thus composed of a composite material of a zirconia-based electrolyte material and Ni such as Ni/YSZ or M₁₋ₓLₓTiO₃ (M is an alkaline earth metal element, L is a lanthanoid element) such as SrTiO₃ system. The lead film 115 derives the DC power which is generated in the plurality of single fuel cells 105 connected in series by the interconnector 107 to the vicinity of the end of the cell stack 101.

In some embodiments, instead of separately providing the fuel-side electrode or the oxygen-side electrode and the substrate tube as described above, the fuel-side electrode or the oxygen-side electrode may thickly be formed to also serve as the substrate tube. Further, although the substrate tube in the present embodiment is described with the substrate tube having the cylindrical shape, a cross section of the substrate tube is not necessarily limited to a circular shape but may be, for example, an elliptical shape, as long as the substrate tube has a tubular shape. A cell stack may be used which has, for example, a flat tubular shape obtained by vertically squeezing a circumferential side surface of the cylinder.

(Configuration of Fuel Cell Power Generation System)

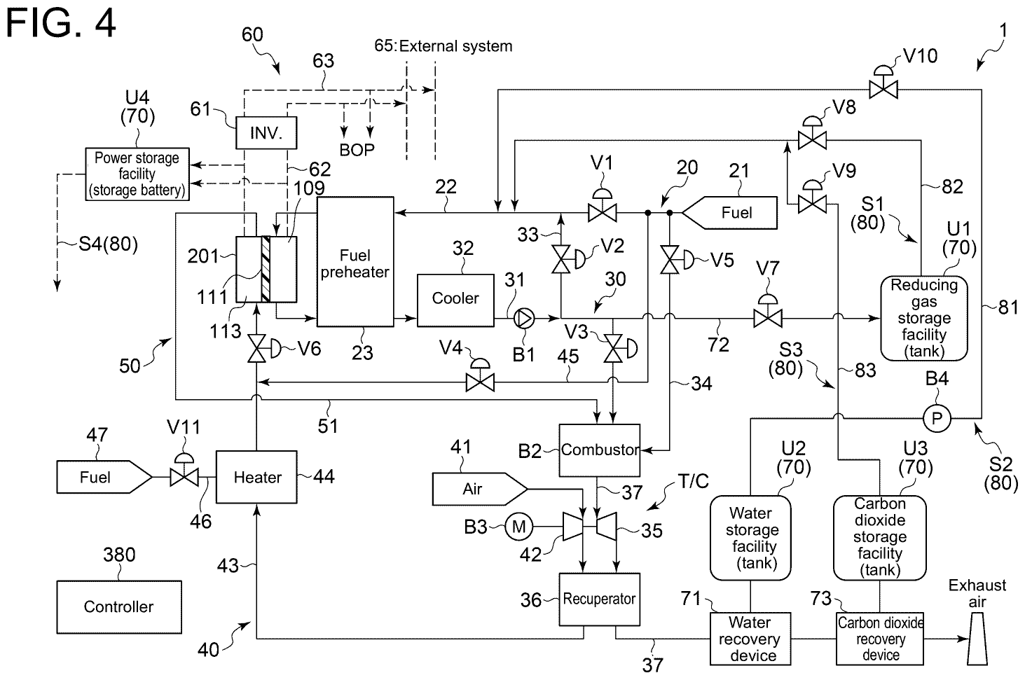

Next, a fuel cell power generation system 1 that uses the fuel cell module 201 having the above configuration will be described. FIG. 4 is a schematic configuration diagram of the fuel cell power generation system 1 according to an embodiment.

The fuel cell power generation system 1 includes a fuel cell module 201 capable of generating power, a fuel gas supply system 20 for supplying a fuel gas to the fuel cell module 201, a fuel gas exhaust system 30 for exhausting an exhaust fuel gas from the fuel cell module 201, an oxidant supply system 40 for supplying an oxidizing gas to the fuel cell module 201, an oxidant exhaust system 50 for exhausting an exhaust oxidized gas from the fuel cell module 201, and a power grid 60 for supplying power generated in the fuel cell module 201 to an external system 65.

The fuel gas supply system 20 includes a fuel gas supply source 21 capable of supplying the fuel gas. The fuel gas supply source 21 is connected to the fuel cell module 201 via a fuel gas supply line 22. On the fuel gas supply line 22, a fuel gas flow control valve V1 is provided which is configured to control the flow rate of the fuel gas flowing through the fuel gas supply line 22. The fuel gas flowing through the fuel gas supply line 22 is preheated by a fuel preheater 23 disposed on the fuel gas supply line 22, and then supplied to the fuel-side electrode 109 of the fuel cell module 201. As will be described later, the fuel preheater 23 is configured to preheat the fuel gas flowing through the fuel gas supply line 22 by exchanging heat with the high-temperature exhaust fuel gas exhausted from the fuel cell module 201.

The fuel gas exhaust system 30 includes a fuel gas exhaust line 31 through which the exhaust fuel gas exhausted from the fuel cell module 201 flows. The exhaust fuel gas flowing through the fuel gas exhaust line 31 is introduced to the fuel preheater 23 and is cooled by exchanging heat with the fuel gas flowing through the fuel gas supply line 22. The exhaust fuel gas having passed through the fuel preheater 23 is further cooled by a cooler 32, and then sent downstream by a recirculation blower B1.

A downstream side of the recirculation blower B1 in the fuel gas exhaust line 31 is connected to a recirculation line 33 communicating with the fuel gas supply line 22. The recirculation line 33 is provided with a recirculation amount control valve V2, and a recirculation amount of the exhaust fuel gas via the recirculation line 33 can be controlled based on the opening degree of the recirculation amount control valve V2.

Further, downstream of the recirculation blower B1 in the fuel gas exhaust line 31, an exhaust fuel gas flow control valve V3 is provided which is configured to control the flow rate of the exhaust fuel gas to a combustor B2. The exhaust fuel gas having passed through the exhaust fuel gas flow control valve V3 is supplied to the combustor B2. In the combustor B2, the exhaust fuel gas is burned together with an exhaust oxidized gas described later, generating an exhaust gas.

The combustor B2 can additionally be supplied with the fuel gas from the fuel gas supply source 21 via an additional fuel gas supply line 34. On the additional fuel gas supply line 34, an additional fuel gas flow control valve V5 is provided which is configured to control an additional supply amount of the fuel gas to the combustor B2. Thus, the fuel gas is additionally supplied to the combustor B2 if the amount of unused fuel contained in the exhaust fuel gas is small, making it possible to generate the exhaust gas by well burning the exhaust fuel gas and the exhaust oxidized gas.

The oxidant supply system 40 includes an oxidant supply source 41 capable of supplying the oxidizing gas. The oxidizing gas from the oxidant supply source 41 is compressed by a compressor 42 composing a turbocharger T/C, and then supplied to the oxygen-side electrode 113 of the fuel cell module 201 via an oxidant supply line 43. The compressor 42 is connected to a turbine 35 that can be driven by the exhaust gas from the combustor B2, and thus is driven by recovering energy of the exhaust gas flowing through an exhaust gas line 37 with the turbine 35.

The oxidizing gas compressed by the compressor 42 passes through the recuperator 36, thereby being increased in temperature by exchanging heat with the high-temperature exhaust gas flowing through the exhaust gas line 37, and then being further heated by a heater 44. The oxidizing gas heated by the heater 44 is supplied to the oxygen-side electrode 113 of the fuel cell module 201 via an oxidizing gas flow control valve V6. The amount of the oxidizing gas supplied to the fuel cell module 201 can be controlled by the opening degree of the oxidizing gas flow control valve V6.

Further, the oxidant supply line 43 can supply the fuel gas from the fuel gas supply source 21 to the oxygen-side electrode 113 of the fuel cell module 201 via an oxygen-side fuel gas supply line 45, as needed. Such supply of the fuel gas to the oxygen-side electrode 113 allows for quick shift to a power generation state, for example, by burning the fuel gas at the oxygen-side electrode 113 to maintain the fuel cell module 201 in a non-power generation state in a high-temperature state (so-called hot standby state). On the oxygen-side fuel gas supply line 45, an oxygen-side fuel gas flow control valve V4 is provided which is configured to control the amount of the fuel gas supplied to the oxygen-side electrode 113.

Further, the heater 44 is connected to a second fuel gas supply source 47 via a heater fuel gas supply line 46. On the heater fuel gas supply line 46, a heater fuel gas flow control valve V11 is provided which is configured to control the amount of the fuel gas supplied from the second fuel gas supply source 47. Thus, the heater 44 can increase the temperature of the oxidizing gas flowing through the oxidant supply line 43, by burning the fuel gas from the second fuel gas supply source 47.

The oxidant exhaust system 50 includes an oxidant exhaust line 51 through which the exhaust oxidized gas exhausted from the oxygen-side electrode 113 of the fuel cell module 201 flows. The oxidant exhaust line 51 is connected to the combustor B2 where the exhaust oxidized gas from the oxidant exhaust line 51 is burned together with the exhaust fuel gas to generate an exhaust gas.

The exhaust gas generated in the combustor B2 drives turbine 35 of the turbocharger T/C disposed on the exhaust gas line 37. The exhaust gas having finished work in the turbine is cooled by exchanging heat with the oxidizing gas in the recuperator 36 and then exhausted to the outside.

The operating efficiency of the turbine 35 decreases if the flow rate of the exhaust gas flowing through the exhaust gas line 37 is low, such as at the startup of the fuel cell power generation system 1, and thus the turbocharger T/C includes an electric motor B3 for driving the compressor 42 in such case.

The power grid 60 includes an inverter 61 for converting DC power output from the fuel cell module 201 into AC power having a predetermined frequency. The inverter 61 is connected to an output end of the fuel cell module 201 via a DC power transmission line 62, and is connected to the external system 65, which is the power supply destination, via an AC power transmission line 63. The external system 65 is, for example, a commercial system having a commercial frequency. In this case, the inverter 61 converts the DC power input from the fuel cell module 201 via the DC power transmission line 62 into AC power having the commercial frequency, and supplies the AC power to the external system 65 via the AC power transmission line 63.

The fuel cell power generation system 1 includes a resource storage part 70 capable of storing resources generated along with the operation of the system, and a resource supply part 80 capable of supplying the resources stored in the resource storage part 70 to at least either of the fuel cell module 201 or the peripheral device. The resources handled by the resource storage part 70 and the resource supply part 80 can include any substance and energy that can be generated along with the operation of the fuel cell power generation system 1. In the present embodiment, a case will be exemplified in which power, water (H₂O), reducing gas (H₂), and carbon dioxide (CO₂) generated during operation of the fuel cell module 201 are handled as the resources. In response thereto, the fuel cell power generation system 1 includes a utility facility (a reducing gas storage facility U1, a water storage facility U2, a carbon dioxide storage facility U3, and electricity storage facility U4) as the resource storage part 70, and correspondingly includes a reducing gas supply part S1, a water supply part S2, a carbon dioxide supply part S3, and a power supply part S4 as the resource supply part 80. Further, the peripheral device can include a wide range of elements other than the fuel cell module 201 among the elements composing the fuel cell power generation system 1. In the present embodiment, auxiliaries (the recirculation blower B1, the combustor B2, the electric motor B3, and a reforming water supply pump B4) are exemplified the peripheral device. The reducing gas storage facility U1 is one aspect of the resource storage part 70

capable of storing the reducing gas generated by the power generation reaction of the fuel cell module 201 as the resource. In the present embodiment, the reducing gas storage facility U1 is configured as a tank capable of storing the reducing gas which is contained in the exhaust fuel gas flowing through the fuel gas exhaust line 31, by being connected via a reducing gas storage line 72 branching from between the recirculation blower B1 and the exhaust fuel gas flow control valve V3 in the fuel gas exhaust line 31. On the reducing gas storage line 72, a reducing gas storage amount control valve V7 is provided which is configured to control the amount of the reducing gas stored in the reducing gas storage facility U1.

The reducing gas stored in the reducing gas storage facility U1 can be supplied to the fuel cell module 201 by the reducing gas supply part S1 which is one aspect of the resource supply part 80. The reducing gas supply part S1 includes a reducing gas supply line 82 connecting between the reducing gas storage facility U1 and the fuel gas supply line 22, and a reducing gas supply amount control valve V8 disposed on the reducing gas supply line 82.

The water storage facility U2 is another aspect of the resource storage part 70 capable of storing water generated by the power generation reaction of the fuel cell module 201 as a resource. In the present embodiment, the water storage facility U2 is connected to a water recovery device 71 disposed downstream of the recuperator 36 in the exhaust gas line 37, and is configured as a tank capable of storing the water which is recovered by the water recovery device 71 from the exhaust gas flowing through the exhaust gas line 37.

Then, the water stored in the water storage facility U2 can be supplied to the fuel cell module 201 by the water supply part S2 which is one aspect of the resource supply part 80. The water supply part S2 includes a water supply line 81 connecting between the water storage facility U2 and the fuel gas supply line 22, a ins supply amount control valve V10 disposed on the water supply line 81, and the reforming water supply pump B4 for pumping water on the water supply line 81.

The carbon dioxide storage facility U3 is another aspect of the resource storage part capable of storing carbon dioxide generated by the reforming reaction of the fuel gas in the fuel cell module 201 as a resource. In the present embodiment, the carbon dioxide storage facility U3 is connected to a carbon dioxide recovery device 73 disposed downstream of the recuperator 36 in the exhaust gas line 37, and is configured as a tank capable of storing the carbon dioxide which is recovered by the carbon dioxide recovery device 73 from the exhaust gas flowing through the exhaust gas line 37.

Then, the carbon dioxide stored in the carbon dioxide storage facility U3 can be supplied to the fuel cell module 201 by the carbon dioxide supply part S3 which is one aspect of the resource supply part 80. The carbon dioxide supply part S3 includes a carbon dioxide supply line 83 connecting between the carbon dioxide storage facility U3 and the reducing gas supply line 82 (substantially the fuel gas supply line 22), and a carbon dioxide supply amount control valve V9 disposed on the carbon dioxide supply line 83.

The power storage facility U4 is one aspect of the resource storage part 70 capable of storing the power generated by the fuel cell module 201 as a resource. In the present embodiment, the power storage facility U4 is configured as a storage battery capable of storing the DC power output from the fuel cell module 201, by being connected to the DC power transmission line 62.

Then, the power stored in the power storage facility U4 can be supplied by the power supply part S4 which is one aspect of the resource supply part 80 to the peripheral devices (for example, auxiliaries (BOP) such as the recirculation blower B1, the electric motor B3, and the reforming water supply pump B4) of the fuel cell power generation system 1.

Further, the fuel cell power generation system 1 includes a controller 380 for controlling each component of the fuel cell power generation system 1. The controller 380 includes, for example, a Central Processing Unit (CPU), a Random Access Memory (RAM), a Read Only Memory (ROM), a computer-readable storage medium, and the like. Then, a series of processes for realizing various functions is stored in the storage medium or the like in the form of a program, as an example. The CPU reads the program out to the RAM or the like and executes processing/calculation of information, thereby realizing the various functions. The program may be applied with a configuration where the program is installed in the ROM or another storage medium in advance, a configuration where the program is provided in a state of being stored in the computer-readable storage medium, a configuration where the program is distributed via a wired or wireless communication means, or the like. The computer-readable storage medium is a magnetic disk, a magneto-optical disk, a CD-ROM, a DVD-ROM, a semiconductor memory, or the like.

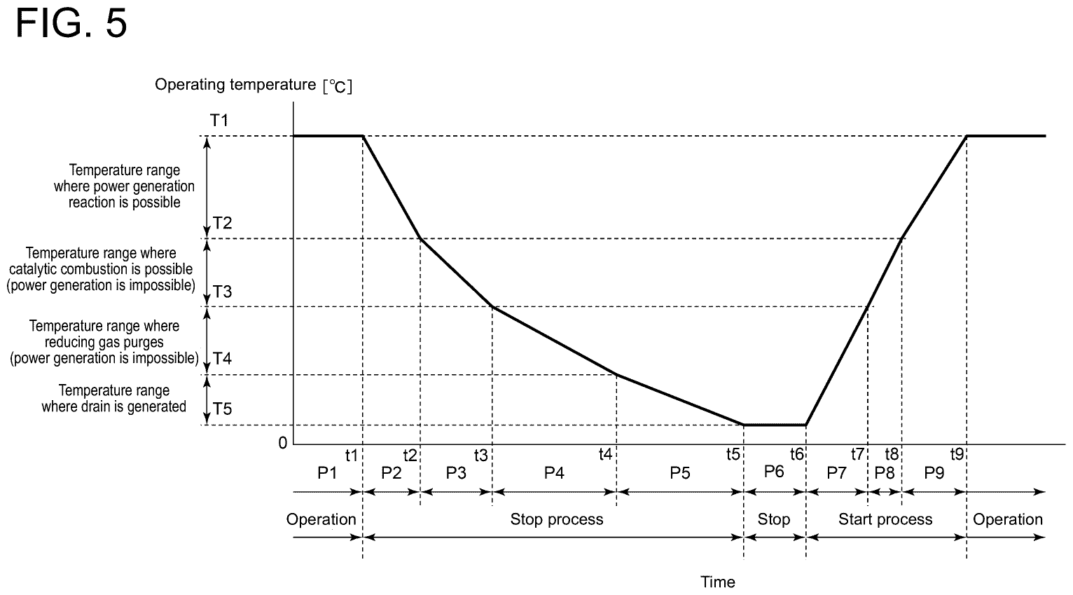

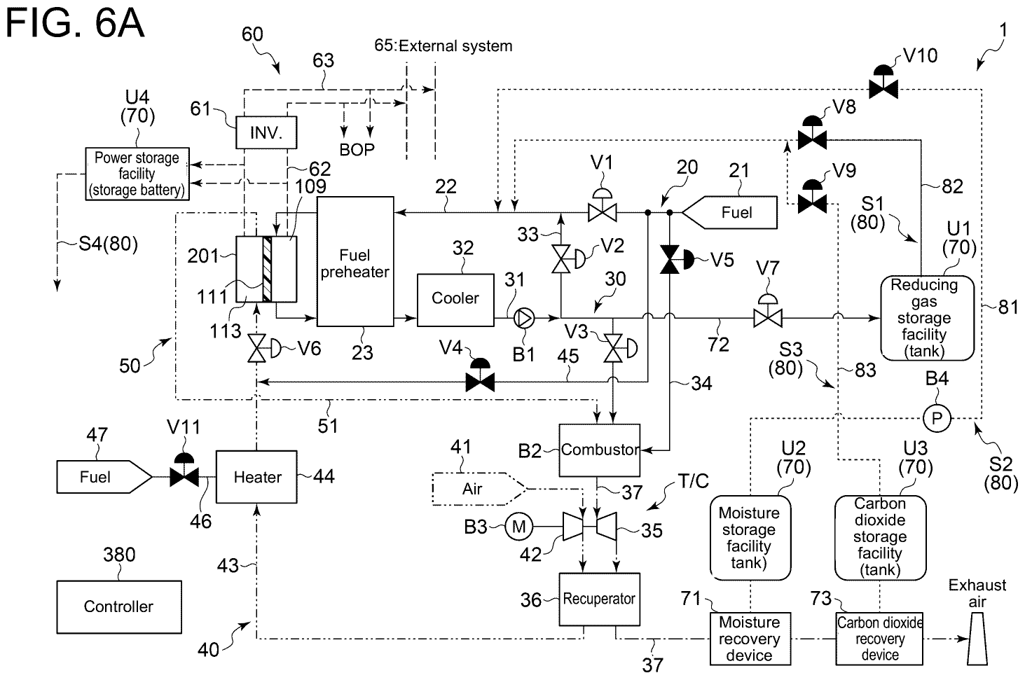

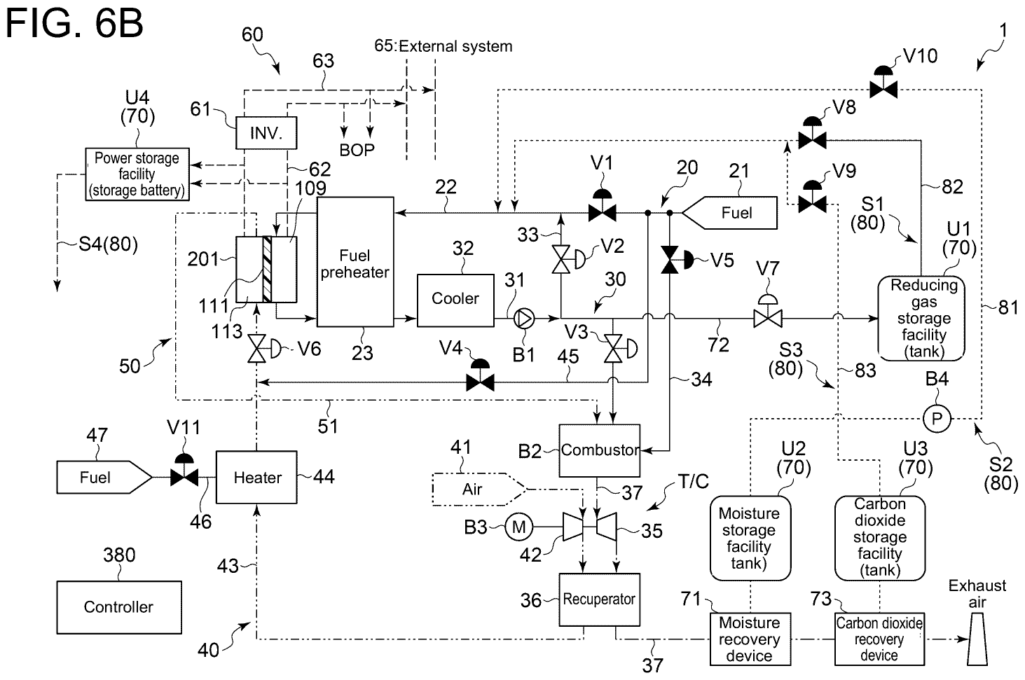

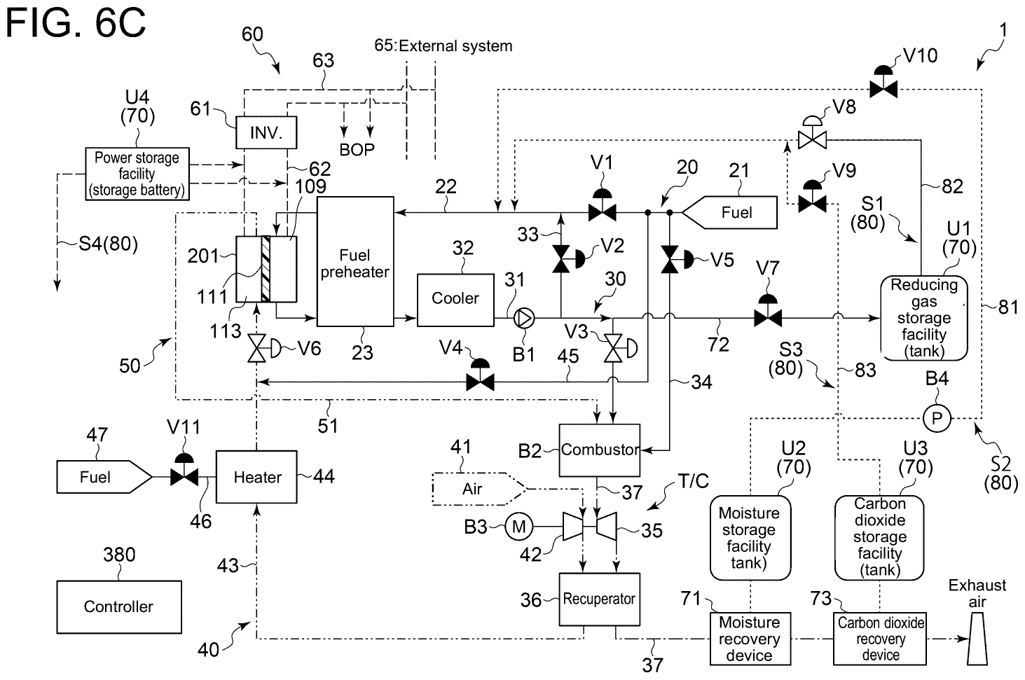

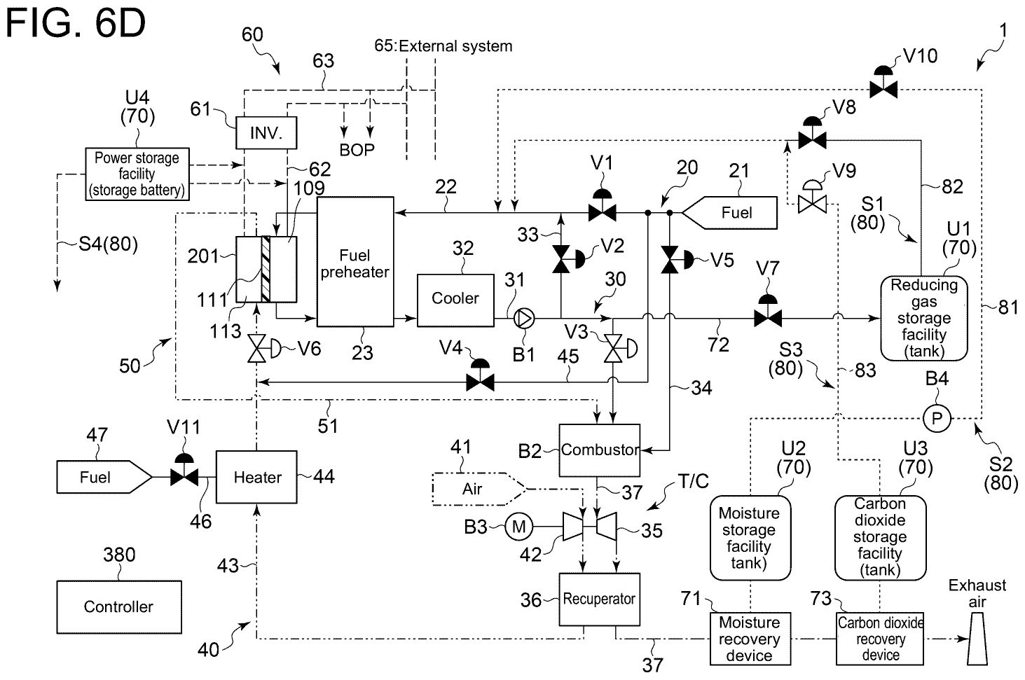

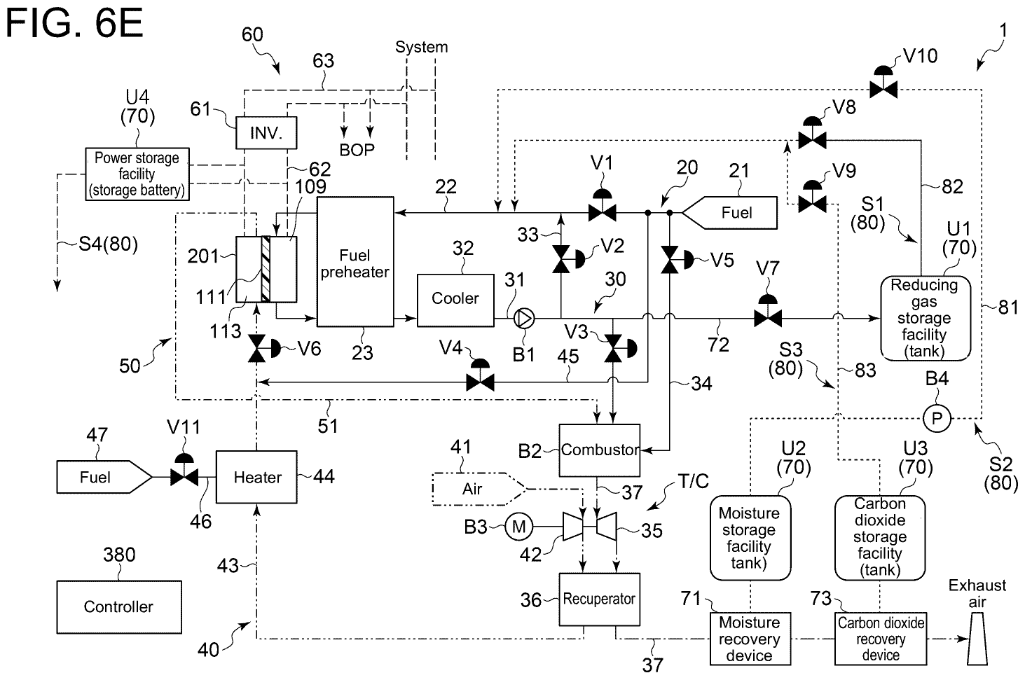

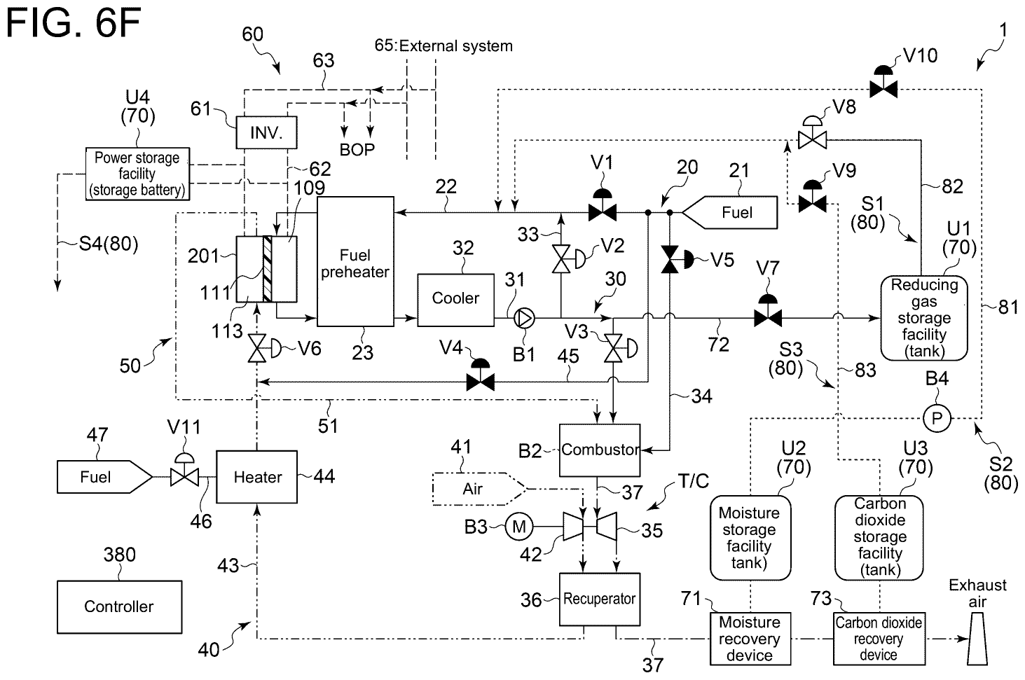

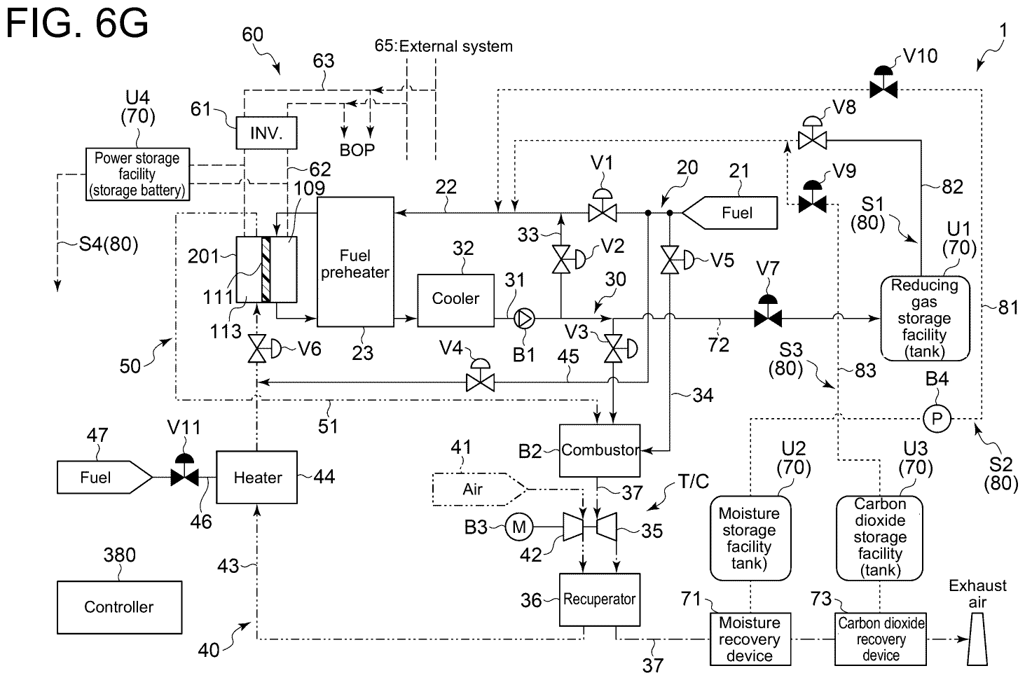

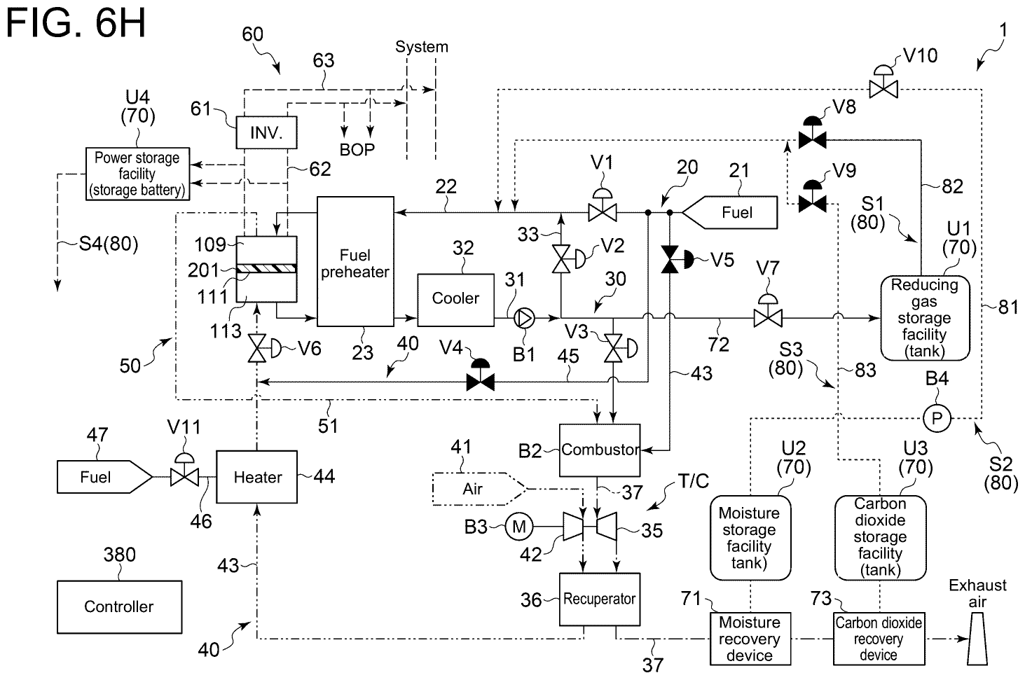

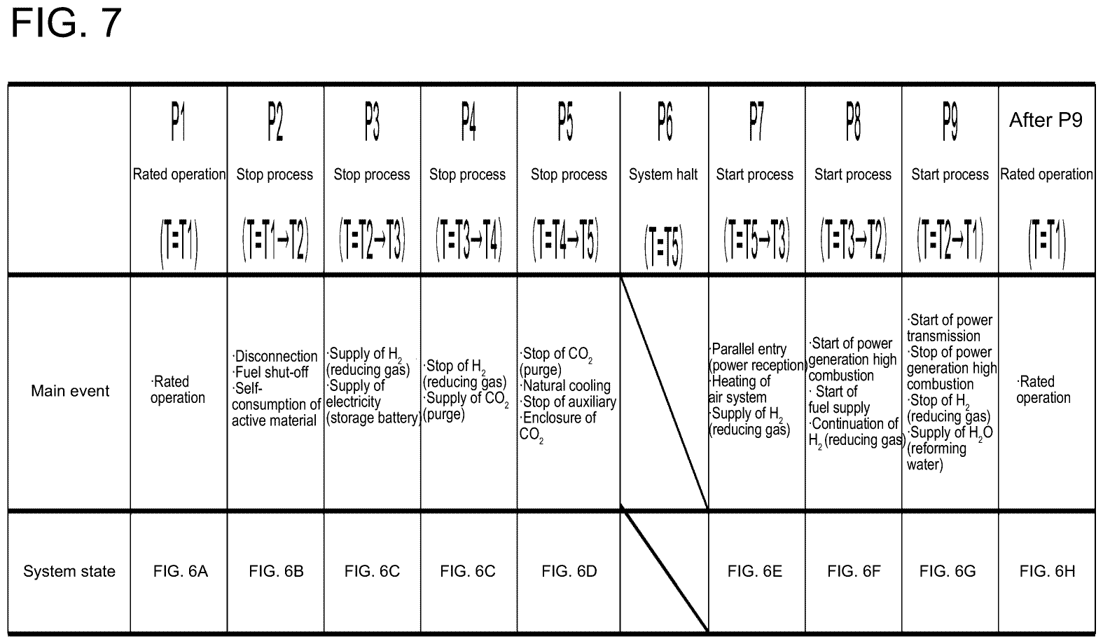

Next, a control method for the fuel cell power generation system 1 having the above configuration will be described. FIG. 5 is a time chart diagram showing a temperature change from a stop process to a start process of the fuel cell power generation system 1. FIGS. 6A to 6H are diagrams, respectively, showing an operating state of the fuel cell power generation system 1 in respective periods P1 to P9 of FIG. 5. FIG. 7 is a table showing operating states of the respective configurations of the fuel cell power generation system 1 in the respective periods P1 to P9 of FIG. 5.

In the present embodiment, as shown in FIG. 5, a description will be given along a series of flows until, with respect to the fuel cell power generation system 1 in the rated operating state, the stop process is started at time t1, a stopped state is realized by completing the stop process at time t5, after that, the start process is started at time t6, and the operation is returned to the original rated operating state at time t9. Such a series of flows is classified into the several periods P1 to P9 based on a temperature T of the fuel cell module 201. Hereinafter, the operating state of the fuel cell power generation system 1 in the respective periods P1 to P9 will specifically be described.

First, in the first period P1 (until the time t1), the fuel cell power generation system 1 is in the rated operating state. In the rated operating state, as shown in FIG. 6A, the fuel gas flow control valve V1, the exhaust fuel gas flow control valve V3, and the oxidizing gas flow control valve V6 are controlled to be open, whereby the power generation reaction is performed in the fuel cell module 201 and the power grid 60 is supplied with power at the rated output. At this time, the temperature T of the fuel cell is a first temperature T1 (the rated operating temperature is approximately 800° C. to 900° C., for example).

In the first period P1, the controller 380 controls the reducing gas storage amount control valve V7 to be open, thereby storing the reducing gas contained in the exhaust fuel gas from the fuel cell module 201 (the reducing gas remaining in the exhaust fuel gas without being consumed in the fuel cell module 201 or the reducing gas generated by the reforming reaction of a carbon component contained in the exhaust fuel gas) in the reducing gas storage facility U1 as the resource. Further, the controller 380 stores the water which is recovered by the water recovery device 71 from the exhaust gas flowing through the exhaust gas line 37 in the water storage facility U2 as the resource, and stores the carbon dioxide recovered by the carbon dioxide recovery device 73 in the carbon dioxide storage facility U3 as the resource. Furthermore, the controller 380 stores the power generated by the fuel cell module 201 in the power storage facility U4 as the resource. By thus storing the resources generated in the fuel cell power generation system 1 in the rated operating state, it is possible to secure and effectively use the resources consumed during the stop process or the start process.

In the first period P1, the controller 380 recirculates part of the exhaust fuel gas from the fuel cell module 201 to the fuel cell module 201 by controlling the recirculation amount control valve V2 to be open, thereby performing the reforming reaction of the fuel gas by using the water contained in the exhaust fuel gas. In the first period P1, the controller 380 controls the oxygen-side fuel gas flow control valve V4, the reducing gas supply amount control valve V8, the carbon dioxide supply amount control valve V9, the water supply amount control valve V10, and the heater fuel gas flow control valve V11 to be closed.

In the second period P2 (time t1 to time t2), as shown in FIG. 5, the temperature T of the fuel cell module 201 gradually decreases from the first temperature T1 (rated operating temperature of approximately 900° C. to 800° C.) at the time t1 when the stop process starts toward a second temperature T2 (lower limit temperature for power generation=approximately 600° C.) T2 at the time t2. As shown in FIG. 6B, the controller 380 stops the supply of the fuel gas to the fuel cell module 201 by controlling the fuel gas flow control valve V1 to be closed, and stops the power supply to the power supply destination (that is, disconnected from the power supply destination). In this process, the fuel cell module 201 is in a high-temperature state equal to or higher than the lower limit temperature for power generation, making it possible to generate power by using the remaining active material (self-consumption). Therefore, the controller 380 stores the power obtained by continuing the power generation in the fuel cell module 201 in the power storage facility U4 as the resource. Further, the controller 380 stores the reducing gas, which is contained in the exhaust fuel gas generated along with the power generation reaction, in the reducing gas storage facility U1 as the resource. Furthermore, the water which is contained in the exhaust gas generated along with the power generation reaction is recovered by the water recovery device 71 and stored in the water storage facility U2 as the resource, and the carbon dioxide contained in the exhaust gas is recovered by the carbon dioxide recovery device 73 and stored in the carbon dioxide storage facility U3 as the resource. Thus, in the second period T2 when the fuel cell module 201 is in the high-temperature state capable of generating power, the resources produced by self-consumption of the remaining active material are stored to effectively be used in the subsequent stop process or start process.

In the second period P2, in order to generate power by self-consumption of the active material in the fuel cell module 201, if the reforming water necessary for reforming the carbon component contained in the fuel gas is insufficient, the controller 380 may supply the water stored in the water storage facility U2 to the fuel cell module 201 as the reforming water by controlling the water supply amount control valve V10 to be open.

In the third period P3 (time t2 to time t3), as shown in FIG. 5, the temperature T of the fuel cell module 201 gradually decreases from the second temperature T2 (lower limit temperature for power generation=approximately 600° C.) at the time t2 to a third temperature T3 (lower limit temperature for catalytic combustion=approximately 400° C.) at the time t3. At this time, since the temperature T of the fuel cell module 201 is not higher than the second temperature T2 which is the lower limit temperature for power generation, the power generation reaction in the fuel cell module 201 is stopped and the non-power generation state is entered. As shown in FIG. 6C, the controller 380 stops storing the reducing gas in the reducing gas storage facility U1 by controlling the reducing gas storage amount control valve V7 to be closed, while supplying the reducing gas stored in the reducing gas storage facility U1 to the fuel cell module 201 as the reducing gas by controlling the reducing gas supply amount control valve V8 to be open and assist-driving the electric motor B3. Thus, the reducing gas can be supplied to the fuel cell module 201 by using the reducing gas stored in advance in the reducing gas storage facility U1. At this time, the assist-driving of the electric motor B3 can also be performed by using the power stored in advance in the power storage facility U4, and thus no power supply from the outside is required and power consumption can be reduced.

The water supply amount control valve V10 is controlled to be closed in the third period P3. In addition to the aforementioned electric motor B3, the power supply from the power storage facility U4 can also be performed for the auxiliaries necessary to realize the operating state, as appropriate.

In the fourth period P4 (time t3 to time t4), as shown in FIG. 5, the temperature T of the fuel cell module 201 gradually decreases from the third temperature T3 (lower limit temperature for catalyst combustion=approximately 400° C.) at the time t3 toward a fourth temperature T4 (lower limit temperature for drain generation=approximately 200° C.) at the time t4. As shown in FIG. 6D, the controller 380 stops the supply of reducing gas for maintaining the reducing state of the fuel system by gradually controlling the reducing gas supply amount control valve V8 to be closed, while supplying carbon dioxide as purge gas from the carbon dioxide storage facility U3 to the fuel-side electrode 109 of the fuel cell module 201 by controlling the carbon dioxide supply amount control valve V9 to be open and assist-driving the electric motor B3. Thus, the purge gas can be supplied to the fuel system of the fuel cell module 201 by using the carbon dioxide stored in advance in the carbon dioxide storage facility U3, without relying on a peripheral device such as an external purge gas cylinder.

The assist-driving of the electric motor B3 in the fourth period P4 can also be performed by using the power stored in advance in the power storage facility U4. In addition to the aforementioned electric motor B3, the power supply from the power storage facility U4 can also be performed for the auxiliaries necessary to realize the operating state, as appropriate.

In the fifth period P5 (time t4 to time t5), as shown in FIG. 5, the temperature T of the fuel cell module gradually decreases from the fourth temperature T4 (lower limit temperature for drain generation=approximately 200° C.) at the time t4 toward a fifth temperature T5 (normal temperature=approximately 25° C.) at the time t5. As shown in FIG. 6E, the controller 380 controls the oxidizing gas flow control valve V6 and the carbon dioxide supply amount control valve V9 to be closed, and controls the exhaust fuel gas flow control valve V3 to be closed after the completion of system purge. Then, the stop process of the fuel cell power generation system 1 is completed by stopping the recirculation blower B1, the turbocharger T/C, and the electric motor B3.

Purging of the fuel cell module 201 in the fourth period P4 and the fifth period P5 may be performed by connecting a device, which can apply a negative pressure such as a vacuum pump, to at least either of the fuel gas supply line 22 or the fuel gas exhaust line to be purged. In this case, by applying the negative pressure to these lines, it is possible to effectively exhaust the gas to be purged remaining in the lines. Driving of the device such as the vacuum pump is also performed by using the power resource stored in the power storage facility U4, eliminating the need for external power supply and making it possible to achieve good system efficiency.

In the sixth period P6 (time t5 to time t6), the fuel cell power generation system 1 is maintained in the stopped state, and as shown in FIG. 5, the temperature T of the fuel cell module 201 is maintained at the fifth temperature T5 (normal temperature=approximately 25° C.).

In the seventh period P7 (time t6 to time t7), as shown in FIG. 5, by starting the start process, the temperature T of the fuel cell module 201 gradually increases from the fifth temperature T5 (normal temperature=approximately 25° C.) at the time t6 to the third temperature T3 (lower limit temperature for catalytic combustion=approximately 400° C.) at the time t7. As shown in FIG. 6F, the controller 380 controls the recirculation amount control valve V2, the exhaust fuel gas flow control valve V3, the oxidizing gas flow control valve V6, the reducing gas supply amount control valve V8, and the heater fuel gas flow control valve V11 to be open, and starts the combustion in the power generation chamber while supplying the reducing gas stored in advance in the reducing gas storage facility U1 to the fuel cell module 201 as the reducing gas by driving the recirculation blower B1 and the electric motor B3.

In the eighth period P8 (time t7 to time t8), as shown in FIG. 5, the temperature T of the fuel cell module gradually increases from the third temperature T3 (lower limit temperature for catalyst combustion=approximately 400° C.) at the time t7 toward the second temperature T2 (lower limit temperature for power generation=approximately 600° C.) at the time t8. As shown in FIG. 6G, the controller 380 controls the fuel gas flow control valve V1 to be open while continuing to supply the reducing gas from the reducing gas storage facility U1 as the reducing gas, thereby supplying the fuel gas to the fuel cell module 201 to start power generation. Further, along with the start of power generation in the fuel cell module 201, the electric motor B3 is stopped and the combustor B2 is started. Consequently, carbon dioxide is recovered by the carbon dioxide recovery device 73 from the exhaust gas generated by the combustor B2, and is stored in the carbon dioxide storage facility U3 as the resource.

In the ninth period P9 (time t8 to time t9), as shown in FIG. 5, the temperature T of the fuel cell module 201 gradually increases from the second temperature T2 (lower limit temperature for power generation=approximately 600° C.) at the time t8 to the first temperature T1 (rated operating temperature=approximately 800° C. to 900° C.) at the time t9. As shown in FIG. 6H, the controller 380 controls the water supply amount control valve V10 to be open and activates the reforming water supply pump B4, thereby supplying the reforming water necessary for power generation in the fuel cell module 201 from the water storage facility U2. Further, the controller 380 stores the power generated by the fuel cell module 201 in the power storage facility U4 as the resource. Furthermore, the controller 380 controls the reducing gas supply amount control valve V8 to be closed and controls the reducing gas storage amount control valve V7 to be open, thereby storing the reducing gas contained in the exhaust fuel gas from the fuel cell module 201 in the reducing gas storage facility U1 as the resource.

In the ninth period P9, the power generation chamber fuel gas flow control valve V4 and the T/C fuel gas flow control valve V5 are controlled to be closed.

After the start process is thus completed at the time t9, the fuel cell power generation system enters the rated operating state as in the aforementioned first period P1.

As described above, in the fuel cell power generation system 1, the resources generated in the stop process are stored in the resource storage part 70, and the resources are supplied to the fuel cell module 201 or the peripheral devices such as the auxiliaries by the resource supply part 80 in the start process of the fuel cell. Since the generation of the resources in the stop process is performed by using the energy remaining in the system in the stop process, the energy remaining in the system is stored in the form of the resources, is not wasted, and can effectively be used in the start process. By thus covering the resources required for the operation of the fuel cell power generation system 1 in the system, it is possible to reduce the number of peripheral devices provided in the system. As a result, it is possible to suppress the installation space or an initial cost of the fuel cell power generation system 1, as well as it is also possible to reduce a running cost by increasing system efficiency, and it is possible to realize the fuel cell power generation system that can be operated at low cost.

The contents described in the above embodiments would be understood as follows, for instance.
(1) A fuel cell power generation system (for example, the fuel cell power generation system 1 of the above-described embodiment) according to one aspect includes: a fuel cell (for example, the fuel cell module 201 of the above-described embodiment); a peripheral device (for example, the auxiliaries such as the recirculation blower B1, the combustor B2, the electric motor B3, and the reforming water supply pump B4) used to operate the fuel cell; a resource storage part (for example, the resource storage part 70 of the above-described embodiment) capable of storing a resource generated in the fuel cell in an operation/stop process of the fuel cell; and a resource supply part (for example, the resource supply part 80 of the above-described embodiment) capable of supplying the resource stored in the resource storage part to at least either of the fuel cell or the peripheral device.
According to the above aspect (1), it is configured such that the resource generated in the operation/stop process of the fuel cell is stored in the resource storage part, and the stored resource is supplied to at least either of the fuel cell or the peripheral device as needed. Since the generation of the resource in the stop process is performed by using the energy remaining in the system, the energy remaining in the system is stored in the form of the resource, is not wasted, and can effectively be used. Such effective use of the resource can improve system efficiency and reduce the number of peripheral devices provided in the system. As a result, it is possible to suppress the installation space or the initial cost of the fuel cell power generation system, as well as it is also possible to reduce the running cost, and it is possible to realize the fuel cell power generation system that can be operated at low cost.
(2) In another aspect, in the above aspect (1), the resource supply part supplies the resource stored in the resource storage part to at least either of the fuel cell or the peripheral device in a start process of the fuel cell.
According to the above aspect (2), the resource stored in the resource storage part is supplied to at least either of the fuel cell or the peripheral device in the start process of the fuel cell. Consequently, the resource stored in the stop process is used to cover the resource required for the start process of the fuel cell power generation system, making it possible to improve system efficiency and reduce the number of peripheral facilities for supplying the resources.
(3) In another aspect, in the above aspect (1) or (2), the resource supply part supplies the resource stored in the resource storage part to at least either of the fuel cell or the peripheral device in the operation/stop process of the fuel cell.
According to the above aspect (3), the resource stored in the resource storage part is supplied to at least either of the fuel cell or the peripheral device in the stop process of the fuel cell. Consequently, the resource stored in the stop process is used to cover the resource required for the stop process of the fuel cell power generation system, making it possible to improve system efficiency and reduce the number of peripheral facilities for supplying the resources.
(4) In another aspect, in any one of the above aspects (1) to (3), the resource storage part includes a power storage facility (for example, the power storage facility U4 of the above-described embodiment) capable of storing power generated in the fuel cell as the resource, if a temperature of the fuel cell is not lower than a lower limit temperature for power generation (for example, the second temperature T2 of the above-described embodiment), and the resource supply part is configured to supply the power stored in the power storage facility to the peripheral device.
According to the above aspect (4), the power generated by the power generation reaction using the fuel remaining in the fuel cell is stored in the power storage facility as the resource, if the temperature of the fuel cell is not lower than the lower limit temperature for power generation in the operation/stop process. Then, the power stored in the power storage facility is supplied to the peripheral device, making it possible to effectively use the energy in the system.
(5) In another aspect, in any one of the above aspects (1) to (4), the resource storage part includes a water storage facility (for example, the water storage facility U2 of the above-described embodiment) capable of storing water generated in the fuel cell as the resource, if a temperature of the fuel cell is not lower than a lower limit temperature for power generation (for example, the second temperature T2 of the above-described embodiment), and the resource supply part is configured to supply the water stored in the water storage facility to the fuel cell as reforming water, if the temperature of the fuel cell reaches or exceeds the lower limit temperature for power generation.
According to the above aspect (5), the water (H₂O) contained in the exhaust gas from the fuel cell is stored in the water storage facility as the resource, if the temperature of the fuel cell is not lower than the lower limit temperature for power generation in the operation/stop process. Then, the water stored in the water storage facility is supplied to the fuel cell as reforming water, making it possible to reduce the number of peripheral devices for supplying reforming water needed in the fuel cell.
(6) In another aspect, in any one of the above aspects (1) to (5), the resource storage part includes a reducing gas storage facility (for example, the reducing gas storage facility U1 of the above-described embodiment) capable of storing reducing gas generated in the fuel cell as the resource, if a temperature of the fuel cell is not lower than a lower limit temperature for power generation (for example, the second temperature T2 of the above-described embodiment), and the resource supply part is configured to supply the reducing gas stored in the reducing gas storage facility to the fuel cell as reducing gas.
According to the above aspect (6), the reducing gas (H₂ etc.) generated in the fuel cell is stored in the reducing gas storage facility as the resource, if the temperature of the fuel cell is not lower than the lower limit temperature for power generation in the stop process. Then, the reducing gas stored in the reducing gas storage facility is supplied to the fuel cell as reducing gas (anode reducing gas), making it possible to reduce the number of peripheral devices for supplying reducing gas.
(7) In another aspect, in any one of the above aspects (1) to (6), the resource storage part includes a carbon dioxide storage facility (for example, the carbon dioxide storage facility U3 of the above-described embodiment) capable of storing carbon dioxide generated in the fuel cell as the resource, if a temperature of the fuel cell is not lower than a lower limit temperature for power generation (for example, the second temperature T2 of the above-described embodiment), and the resource supply part is configured to supply the carbon dioxide stored in the carbon dioxide storage facility to the fuel cell as purge gas.
According to the above aspect (7), the carbon dioxide (CO2) contained in the exhaust gas from the fuel cell is stored in the carbon dioxide storage facility as the resource, if the temperature of the fuel cell is not lower than the lower limit temperature for power generation in the stop process. Then, the carbon dioxide stored in the carbon dioxide storage facility is supplied to the fuel cell as purge gas (inert gas) for preventing deterioration in the cell unit, making it possible to reduce the number of peripheral devices for supplying purge gas.
(8) In another aspect, in the above aspect (7), the resource supply part is configured to supply the carbon dioxide to the fuel cell such that no drain is generated in the fuel cell.
According to the above aspect (8), when the carbon dioxide stored as the resource in the start process is supplied to the fuel cell, the carbon dioxide is supplied such that no drain is generated in the fuel cell. Thus, it is possible to effectively prevent deterioration in the fuel cell due to the drain.
(9) A control method for a fuel cell power generation system according to an aspect is a control method for a fuel cell power generation system that includes a fuel cell, and a peripheral device used to operate the fuel cell, including: a step of storing a resource generated in the fuel cell in an operation/stop process of the fuel cell; and a step of supplying the resource to at least either of the fuel cell or the peripheral device.
According to the above aspect (9), it is configured such that the resource generated in the operation/stop process of the fuel cell is stored in the resource storage part, and the stored resource is supplied to at least either of the fuel cell or the peripheral device as needed. Since the generation of the resource in the stop process is performed by using the energy remaining in the system, the energy remaining in the system is stored in the form of the resource, is not wasted, and can effectively be used. Such effective use of the resource can improve system efficiency and reduce the number of peripheral devices provided in the system. As a result, it is possible to suppress the installation space or the initial cost of the fuel cell power generation system, as well as it is also possible to reduce the running cost, and it is possible to realize the control method for the fuel cell power generation system that can be operated at low cost.

### REFERENCE SIGNS LIST

1 Fuel cell power generation system
20 Fuel gas supply system
21 Fuel gas supply source
22 Fuel gas supply line
23 Fuel preheater
30 Fuel gas exhaust system
31 Fuel gas exhaust line
32 Cooler
33 Recirculation line
34 Additional fuel gas supply line
35 Turbine
36 Recuperator
37 Exhaust gas line
40 Oxidant supply system
41 Oxidant supply source
42 Compressor
43 Oxidant supply line
44 Heater
45 Oxygen-side fuel gas supply line
46 Heater fuel gas supply line
47 Second fuel gas supply source
50 Oxidant exhaust system
51 Oxidant exhaust line
60 Power system
61 Inverter
62 DC power transmission line
63 AC power transmission line
70 Resource storage part
71 Water recovery device
72 Reducing gas storage line
73 Carbon dioxide recovery device
80 Resource supply part
81 Water supply line
82 Reducing gas supply line
83 Carbon dioxide supply line
101 Cell stack
103 Substrate tube
105 Single fuel cell
107 Interconnector
109 Fuel-side electrode
111 Electrolyte
113 Oxygen-side electrode
115 Lead film
201 Fuel cell module
203 Cartridge
205 Pressure vessel
207 Fuel gas supply pipe
207a Fuel gas supply branch pipe
209 Fuel gas exhaust pipe
209a Fuel gas exhaust branch pipe
215 Power generation chamber
217 Fuel gas supply header
219 Fuel gas exhaust header
221 Supply header
221 Oxidant supply header
223 Oxidant exhaust header
225a Upper tube plate
225b Lower tube plate
227a Upper heat insulating body
227b Lower heat insulating body
229a Upper casing
229b Lower casing
231a Fuel gas supply hole
231b Fuel gas exhaust hole
233a Oxidant supply hole
233b Oxidant exhaust hole
235a Oxidant supply gap
235b Oxidant exhaust gap
237a, 237b Seal component
380 Controller
35 Recirculation blower
4 Combustor
B3 Electric motor
B4 Reforming water supply pump

1. A fuel cell power generation system, comprising:
a fuel cell;
a peripheral device used to operate the fuel cell;
a resource storage part capable of storing a resource generated in the fuel cell in an operation/stop process of the fuel cell; and
a resource supply part capable of supplying the resource stored in the resource storage part to at least either of the fuel cell or the peripheral device.

2. The fuel cell power generation system according to claim 1,
wherein the resource supply part supplies the resource stored in the resource storage part to at least either of the fuel cell or the peripheral device in a start process of the fuel cell.

3. The fuel cell power generation system according to claim 1,
wherein the resource supply part supplies the resource stored in the resource storage part to at least either of the fuel cell or the peripheral device in the operation/stop process of the fuel cell.

4. The fuel cell power generation system according to claim 1,
wherein the resource storage part includes a power storage facility capable of storing power generated in the fuel cell as the resource, if a temperature of the fuel cell is not lower than a lower limit temperature for power generation, and
wherein the resource supply part is configured to supply the power stored in the power storage facility to the peripheral device.

5. The fuel cell power generation system according to a claim 1,
wherein the resource storage part includes a water storage facility capable of storing water generated in the fuel cell as the resource, if a temperature of the fuel cell is not lower than a lower limit temperature for power generation, and
wherein the resource supply part is configured to supply the water stored in the water storage facility to the fuel cell as reforming water, if the temperature of the fuel cell reaches or exceeds the lower limit temperature for power generation.

6. The fuel cell power generation system according to claim 1,
wherein the resource storage part includes a reducing gas storage facility capable of storing reducing gas generated in the fuel cell as the resource, if a temperature of the fuel cell is not lower than a lower limit temperature for power generation, and
wherein the resource supply part is configured to supply the reducing gas stored in the reducing gas storage facility to the fuel cell as reducing gas.

7. The fuel cell power generation system according to claim 1,
wherein the resource storage part includes a carbon dioxide storage facility capable of storing carbon dioxide generated in the fuel cell as the resource, if a temperature of the fuel cell is not lower than a lower limit temperature for power generation, and
wherein the resource supply part is configured to supply the carbon dioxide stored in the carbon dioxide storage facility to the fuel cell as purge gas.

8. The fuel cell power generation system according to claim 7,
wherein the resource supply part is configured to supply the carbon dioxide to the fuel cell such that no drain is generated in the fuel cell.

9. A control method for a fuel cell power generation system that includes
a fuel cell, and
a peripheral device used to operate the fuel cell, comprising:
a step of storing a resource generated in the fuel cell in an operation/stop process of the fuel cell; and
a step of supplying the resource to at least either of the fuel cell or the peripheral device.
